(19) United States
(12) Patent Application Publication
(10) Pub. No.: US 2013/0265235 A1
(43) Pub. Date: Oct. 10, 2013

(54) FLOATING NAVIGATIONAL CONTROLS IN A TABLET COMPUTER

(71) Applicants: Xinmei Cai, Tokyo (JP); Timothy Charles Jones, Godmanchester (GB); Andrey Doronichev, London (GB)

(72) Inventors: Xinmei Cai, Tokyo (JP); Timothy Charles Jones, Godmanchester (GB); Andrey Doronichev, London (GB)

(73) Assignee: GOOGLE INC., Mountain View, CA (US)

(21) Appl. No.: 13/443,567

(22) Filed: Apr. 10, 2012

(51) Int. Cl. G06F 3/02; G06F 3/01

(52) U.S. Cl. 345/169; 345/156

(57) ABSTRACT

Aspects relate to placement of navigational controls on the left bottom position, the right bottom position, or both the left bottom and right bottom position on a tablet computer display. The placement selection of the navigational controls can be a function of orientation of a user's thumb(s). A navigational area can be defined with respect to a range of movement of the user's thumb(s) and/or size of the user's thumb(s). Further, the navigational controls can be switched between left-hand control and right-hand control as a function of a user preference. When the display is switched between portrait and landscape mode, the navigational controls can be automatically adjusted as a function of the navigational area and the display mode.

### TECHNICAL FIELD

This disclosure relates to floating navigational controls associated with a tablet computer.

### BACKGROUND

Users of tablet computers navigate computer contents through interaction with navigational controls that are typically located at the top of the tablet computer screen. At times, the navigational controls at the top of the screen might be difficult to reach. For example, when the consumer is holding the tablet computer in a landscape orientation, the user's hand must traverse from its position on either side of the computer to the navigation controls located at the top of the screen. In another example, the primary navigation is on the left hand side, which is not ideal for right-handed people. Thus, the consumer might hold the tablet computer in an uncomfortable position in order to properly access the navigational controls.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope of particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with a dynamically adjustable user interface for a tablet computer, wherein the navigational controls are placed in a configurable location so as to be easily accessed by the thumbs for touch screen actions.

An aspect relates to a system that can comprise a memory and a processor. The memory stores computer executable components that are executable by the processor. The computer executable components can include a navigation component that can render control features on a display of a tablet computer. An adjustment component can modify placement of the control features as a function of a user's thumb orientation. The computer executable components can also include a retention component that can maintain the control features at the modified placement.

Another aspect relates to a method that can comprise using a processor to execute computer executable instructions stored in a memory. The computer executable instructions can include rendering a plurality of control features on a display of a tablet computer and modifying a placement of at least a subset of the plurality of control features within the display based in part on ergonomic considerations associated with a user. The computer executable instructions can also include retaining information related to an association between the modified placement and the user, wherein the user is distinguished from at least one other user.

A further aspect relates to a device that can comprise a memory that stores computer executable components and a processor that executes the executable components stored in the memory. The executable components can include a navigation component that can display control features on a tablet computer display and a calibration component that can detect at least one of a thumb size or a range of movement. The executable components can also include an adjustment component that can modify placement of a first subset of the control features within a navigational area. The navigational area can comprise an area defined based on the thumb size or the range of movement. Further, the executable components can include a modification component that can receive a change to one or more control features within the first subset. The adjustment component can apply the received change to the one or more control features. The executable components can also include a retention component that can associate the placement of the first subset of the control features with a user and store information related to the association.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

Various non-limiting implementations are further described with reference to the accompanying drawings in which:

FIG. 1 illustrates an example non-limiting system that provides floatable navigation control, according to an aspect;

FIG. 2 illustrates an exemplary display area having navigational areas accessible by a user's thumbs, according to an aspect;

FIG. 3 illustrates a non-limiting representation of a line drawing of an exemplary instance of the display wherein a floating control bar is located on a right lower portion of the display, in accordance with some aspects;

FIG. 4 illustrates another non-limiting representation of a line drawing of an exemplary instance of the display wherein the floating control bar is located on a left lower portion of the display, according to an aspect;

FIG. 5 illustrates a further non-limiting representation of a line drawing showing two floating control bars located on the lower left and lower right portions of the display shown in a landscape orientation, according to an aspect;

FIG. 6 illustrates a non-limiting example of the display shown in a portrait orientation;

FIG. 7 illustrates another example non-limiting embodiment of a system that identifies a range of movement and/or a size of a user's thumbs, according to an aspect;

FIG. 8 illustrates another example non-limiting embodiment of a system that allows a user to fine tune one or more control features and/or floating control bars, according to an aspect;

FIG. 9 illustrates another example non-limiting embodiment of a system that identifies a current user of the tablet computer, according to an aspect;

FIG. 10 illustrates another example non-limiting embodiment of a system that adjusts a positioning of the navigation elements as a function of whether the user is left-handed or right-handed, according to an aspect;

FIG. 11 illustrates an example non-limiting method for providing floating navigational controls, according to an aspect;

FIG. 12 illustrates another example non-limiting method for providing floating navigational controls, according to an aspect;

FIG. 13 illustrates a block diagram representing an exemplary non-limiting networked environment in which the various embodiments can be implemented; and

FIG. 14 illustrates a block diagram representing an exemplary non-limiting computing system or operating environment in which the various embodiments may be implemented.

### DETAILED DESCRIPTION

Various aspects or features of the subject disclosure are described with reference to the drawings, wherein like reference numerals are used to refer to like elements throughout. In the following description, for purposes of explanation, numerous specific details are set forth in order to provide a thorough understanding of the subject disclosure. It may be evident, however, that the disclosed subject matter can be practiced without these specific details, or with other methods, components, materials, and so forth. In other instances, well-known structures and components are shown in block diagram form in order to facilitate describing the subject disclosure.

It is to be appreciated that in accordance with one or more implementations described in this disclosure, users can opt-out of providing personal information, demographic information, location information, proprietary information, sensitive information, or the like in connection with data gathering aspects. Moreover, one or more implementations described herein can provide for anonymizing collected, received, or transmitted data.

By way of introduction, the subject matter disclosed herein relates to placing navigational controls in an adaptable and convenient location in at least one lower quadrant of a table computer display. For example, one or more floating navigation control bars can be located at the left bottom, at the right bottom, or at both the left bottom and the right bottom position of a tablet computer display. In accordance with some aspects, the placement can be selected as a function of accessibility by a user's thumb(s) for touch screen action (e.g., based on ergonomic considerations associated with a user). In an example, the navigational area can be the area within the range of movement of the user's thumb(s).

An aspect relates to a system that includes a memory and a processor. The memory can store computer executable components that can be executed by the processor. The computer executable components can include a navigation component that can render control features on a display of a tablet computer. Another computer executable component can be an adjustment component that can modify a placement of the control features as a function of a user's thumb orientation. The computer executable components can also include a retention component that can maintain the control features at the modified placement.

In an aspect, the adjustment component can place a first subset of the control features at a left bottom portion of the display and a second subset of the control features at a right bottom portion of the display.

In some aspects, the system can also comprise a calibration component that can identify at least one of a range of movement or a size of a user's thumb. Further to this aspect, the adjustment component can change placement of the control features in response to the range of movement or size of the user's thumb.

According to another aspect, the system can also comprise a modification component that can receive user modification to one or more of the control features. Further to this aspect, the user modification can relate to size or position of the one or more control features.

In accordance with other aspects, the system can comprise a user identification component that can detect a user of the tablet computer. Further to this aspect, the adjustment component can modify the placement for the user based in part on information received from the retention component. In a further example, the user identification component can detect the user based on a biometric feature of the user.

The adjustment component, in another aspect, can modify the placement of the control features within a navigational area of the display. Further to this aspect, the navigational area can comprise an area within a range of movement of a user's thumb.

The system, in a further aspect, can comprise a toggle component that can switch placement of the control features between a left layout and a right layout based on whether a user is left handed or right handed. In yet another aspect, the system can include a mode component that can adjust the placement of the control features as the tablet computer is changed between a portrait orientation and a landscape orientation.

The floating control bar can comprise the control features, according to an aspect. Further, the control features can be transparently (or semi-transparently) displayed to allow viewing of elements underneath the floating control bar. In another aspect, the floating control bar can be a floating menu or a re-positionable menu. In still another aspect, the floating control bar can be accessible at a left bottom portion or a right bottom portion, or both the left bottom portion and the right bottom portion of the display.

A further aspect relates to a device that includes a memory that stores computer executable components and a processor that executes the executable components stored in the memory. The executable components can include a navigation component that can display control features on a tablet computer display and a calibration component that can detect at least one of a thumb size or a range of movement. The executable components can also include an adjustment component that can modify a placement of a first subset of the control features within a navigational area. The navigational area can comprise an area defined based on the thumb size or the range of movement. Further, the executable components can include a modification component that can receive a change to one or more control features within the first subset. The adjustment component can apply the received change to the one or more control features. The executable components can also include a retention component that can associate the placement of the first subset of the control features with a user and store information related to the association.

The device, according to an aspect, can also comprise a user identification component that can identify a current user of the device. Further to this aspect, the retention component can retrieve the information related to the placement of the first subset of the control features for the current user and the adjustment component can cause the first subset of the control features to be displayed at the modified placement.

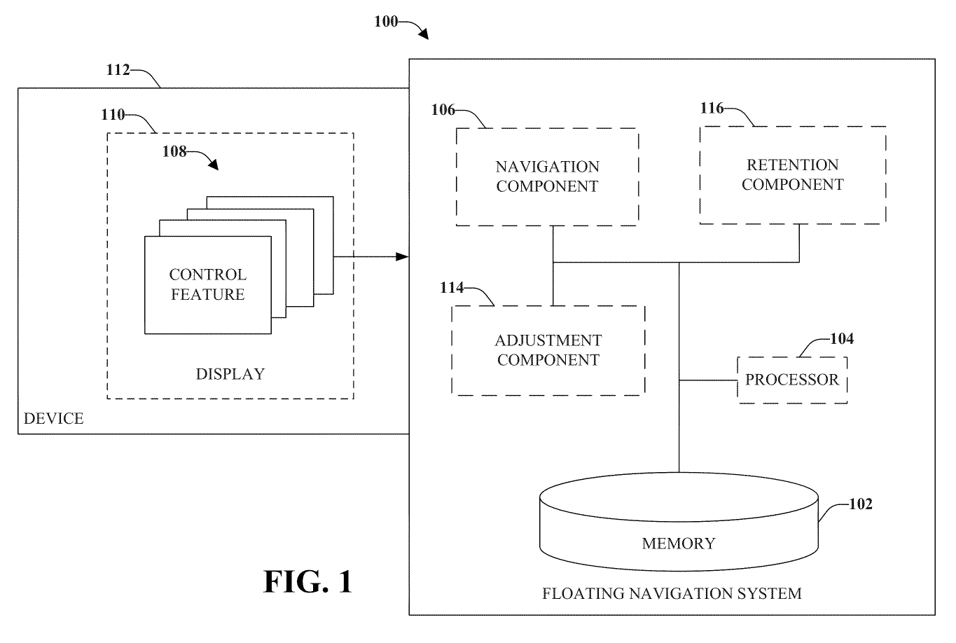

Referring initially to FIG. 1, illustrated is an example non-limiting system 100 that provides floatable navigation control, according to an aspect. System 100 provides a dynamically adjustable user interface, wherein navigational controls are placed in a configurable location so as to be easily accessed by the thumbs for touch screen actions. Various aspects of the systems, apparatuses, and/or processes explained in this disclosure can constitute machine-executable components embodied within one or more machines, such as, for example, embodied in one or more computer readable mediums (or media) associated with one or more machines. Such component(s), when executed by the one or more machines (e.g., computer(s), computing device(s), virtual machine(s), and so on) can cause the machine(s) to perform the operations described. System 100 can include a memory 102 that stores computer executable components and instructions. System 100 can also include a processor 104 that executes computer executable components stored in the memory 102. It should be noted that although one or more computer executable components may be described herein and illustrated as components separate from memory 102, in accordance with various aspects, the one or more computer executable components could be stored in memory 102.

The system 100 can be configured to place the navigation for controls at a position that is convenient for access by a user's thumb(s) and that is configurable or can be changed manually by the user or can be changed automatically (e.g., based on an inference, a user identification, user preferences, a screen orientation, a type of application being executed, and so forth). For example, the main navigation for an application website can be placed at either or both of the lower bottom corners or quadrants of a display (e.g., left and/or right), such as a tablet computer display. Placing the navigation controls at either or both of the lower quadrants can provide ease of navigation control when a user is reclining on a sofa while using the tablet computer, for example.

In some aspects, the navigation control can be positioned as a function of whether the user is left-handed, right handed, and/or ambidextrous. In an example, the user might be right-handed and mainly use his right thumb, but due to a medical condition (e.g., broken thumb, broken hand, and so forth) might need to use his left thumb. Therefore, the user can, at least temporarily, modify the navigation controls such that the controls are located on a bottom left of the display area. In some aspects, the user might alternate or use his left thumb for a first subset of controls and his right thumb for a second subset of controls, therefore, controls can be placed on both the left bottom and the right bottom of the display. In accordance with some aspects, the system 100 can be configured so that the placement of the selected controls can be based on user preferences.

In an embodiment, system 100 comprises a navigation component 106 that can display one or more control features 108 on a display 110 associated with a device 112. In accordance with some aspects, system 100 can be retained in device 112. In an example, the device 112 can be a computer (e.g., a mobile computer) that is operated by the user through interaction with a touch screen rather than using a physical keyboard and/or mouse. In accordance with some aspects, a virtual keyboard (e.g., onscreen virtual keyboard), a stylus pen, or a digital pen, might be utilized to operate the computer. In an example, the computer is a tablet computer. The terms “tablet computer”, “tablet”, or “device” may be used interchangeably herein.

The one or more control features 108 are the various commands that the user can select to perform operations with the device. For example, a control feature can be a request to return to a “home” screen (e.g., while surfing the Internet). Other control features can include a command to “browse” or to bring up a list of “favorites”. Further examples of control features can include a command to display an “inbox” (e.g., for an email application) or to display other items, such as “my videos”, “playlists”, “settings, “subscriptions” and so forth. Control features that allow the user to interact with the system, in addition to those discussed herein, can be utilized with the disclosed aspects.

The system 100 can also comprise an adjustment component 114 that can modify placement of at least a subset of the control features 108. For example, the system 100 can be initially configured to render the control features 108 at a default location on the display 110 (e.g., a top of the display 110). There might be times when the default location is acceptable and the user can control the device 112 using the navigation, such as when the device is placed on a flat surface (e.g., desk, table, and so forth).

However, there might be times when the location of the control features is not conducive for efficient control and operation of the device 112. For example, the user of the device, such as a teenager, might want to use the device while reclining on a couch or other surface (e.g., lying on the floor, lying in bed, sitting in a beanbag chair, and so forth). When in the reclined position, navigation controls at the top of the display would render operation of the device cumbersome. For example, the user would have to move his hands from a position at the bottom of the device (where the hands are holding the device) to the top of the screen. The movement of the hands in this matter is not only cumbersome but can increase fatigue and/or user frustration.

To improve the user experience, the adjustment component 114 can modify placement of at least one control feature within a navigational area of the display 110. In an aspect, placement of the subset of the control features 108 is modified by the adjustment component 114 as a function of thumb orientation. For example, the navigation component 106 can provide information related to the one or more control features 108 to the adjustment component 114. Such information can include a default position for each of the one or more control features 108. The adjustment component 114 can calculate a difference (which can be expressed as a distance) between the default position and the placement (or expected placement) of a user's thumb(s) and change the position of the one or more control features 108 based, in part, on the calculation.

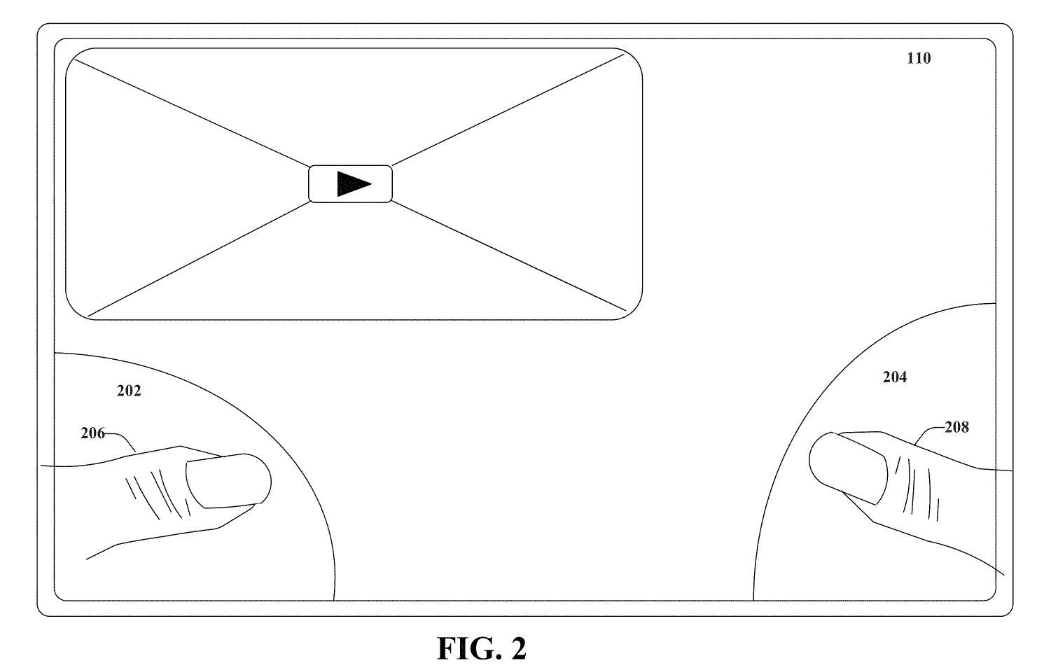

For example, as illustrated in FIG. 2, the display 110 can include one or more navigational areas, where a first navigational area 202 and a second navigational area 204 are shown. The navigational areas 202, 204 are defined as an area within a movement range of the user's thumb(s) 206, 208. In an aspect, the movement range of the thumb(s) can be defined by the saddle joint of the user's thumb(s). The saddle joint allows for side-to-side motion (e.g., up and down) as well as back-and-forth motion (e.g., across the palm) of the thumb, but does not allow for rotation. Thus, when the user in lying back on a sofa and is holding the tablet computer in his lap, for example, the user is able to control the tablet computer by moving his thumbs, which are already in close proximity to the display, instead of having to move his hand and arm. The navigational area(s) can be different for different users. For example, a first user might have large hands and a second user might have small hands, thus, the navigational area(s) can be larger (both vertically and horizontally) for the first user.

As mentioned above, placement of at least one control feature can be modified by the adjustment component 114. In accordance with some aspects, placement of more than one control feature or, in some aspects, placement of substantially all the control features are modified by the adjustment component 114. In some aspects, the control features 108 can be divided into two or more subsets of control features, wherein a first subset is placed in a first location and a second subset is placed in a second location on the display. For example, the first subset can be placed in a lower left hand corner of the display and the second subset can be placed in a lower right hand corner of the display. In some aspects, one or more control features 108 are duplicated in both the first subset and the second subset (e.g., a “home” control feature).

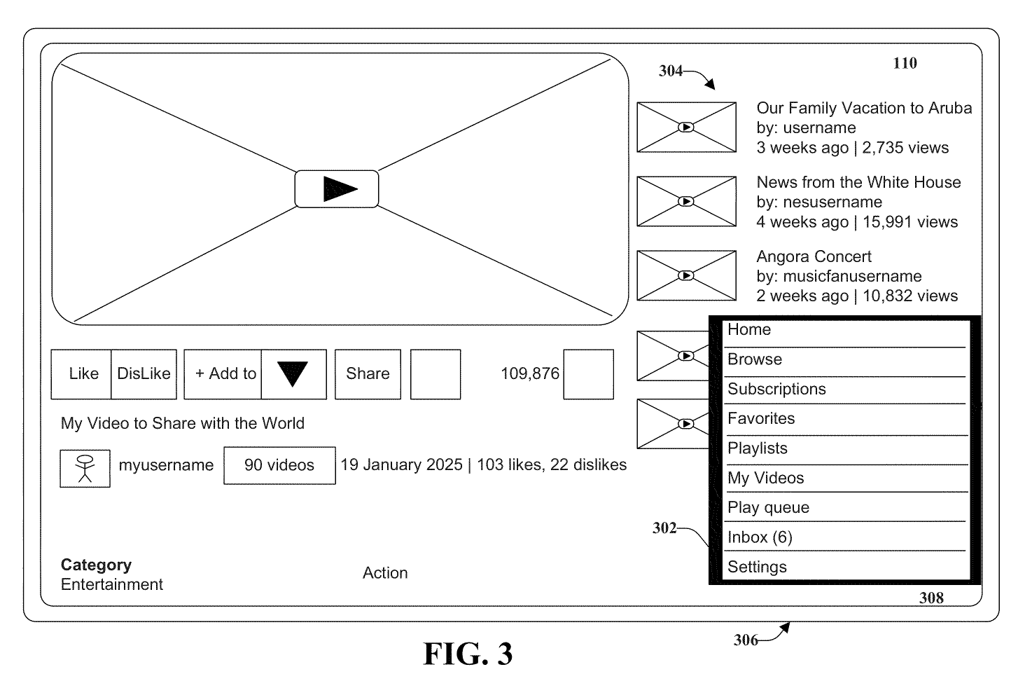

With reference also to FIG. 3, which illustrates a non-limiting representation of a line drawing of an exemplary instance of the display 110, in accordance with some aspects, the adjustment component 114 can modify placement of a floating control bar 302 within the display 110. In an example, the floating control bar 302 can include one or more control features 108, illustrated as nine control features that include “Home”, “Browse”, “Subscriptions”, “Favorites”, “Playlists”, “My Videos”, “Play queue” “Inbox (6)”, and “Settings”. It should be understood that according to various aspects, the one or more floating control bars can include fewer or more control features than those shown and described.

In various aspects, the floating control bar can be a floating menu or a re-positionable menu. The floating control bar 302 can be placed substantially over other elements that are displayed, such as the illustrated listing of videos 304 that are being rendered on the display 110. In some aspects, the user can reposition or move the floating control bar, as desired, if the user would like to view what is located underneath the floating control bar (e.g., the listing of videos). In accordance with some aspects, the floating control bar can be substantially transparent such that the elements underneath the floating control bar can be perceived by the user. A transparent floating control bar allows for viewing of both the floating control bar and the elements under the floating control at substantially the same time.

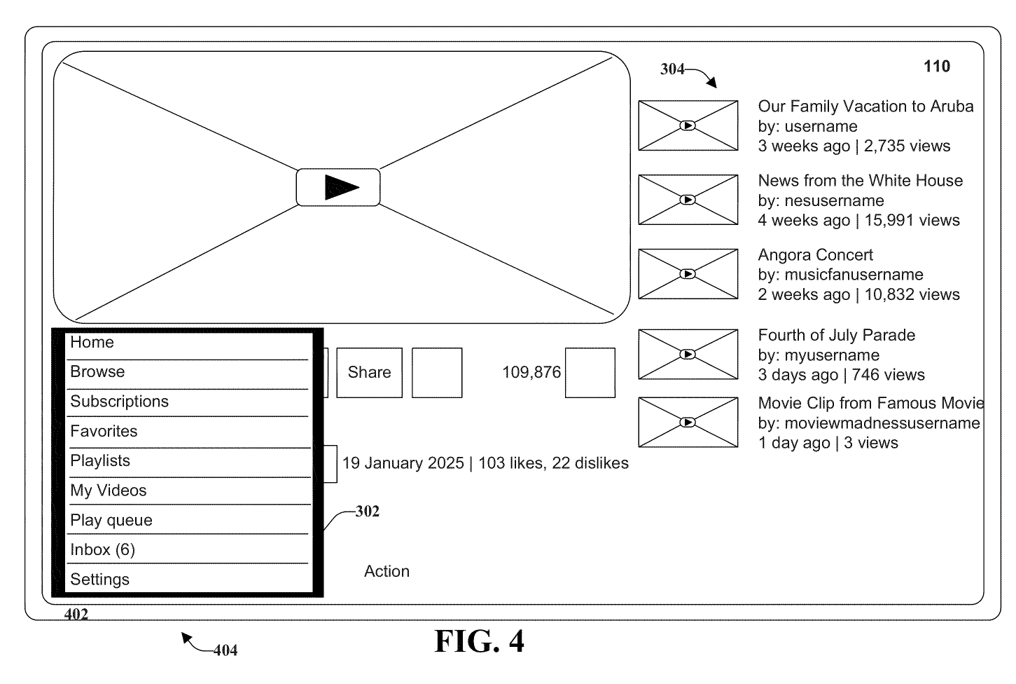

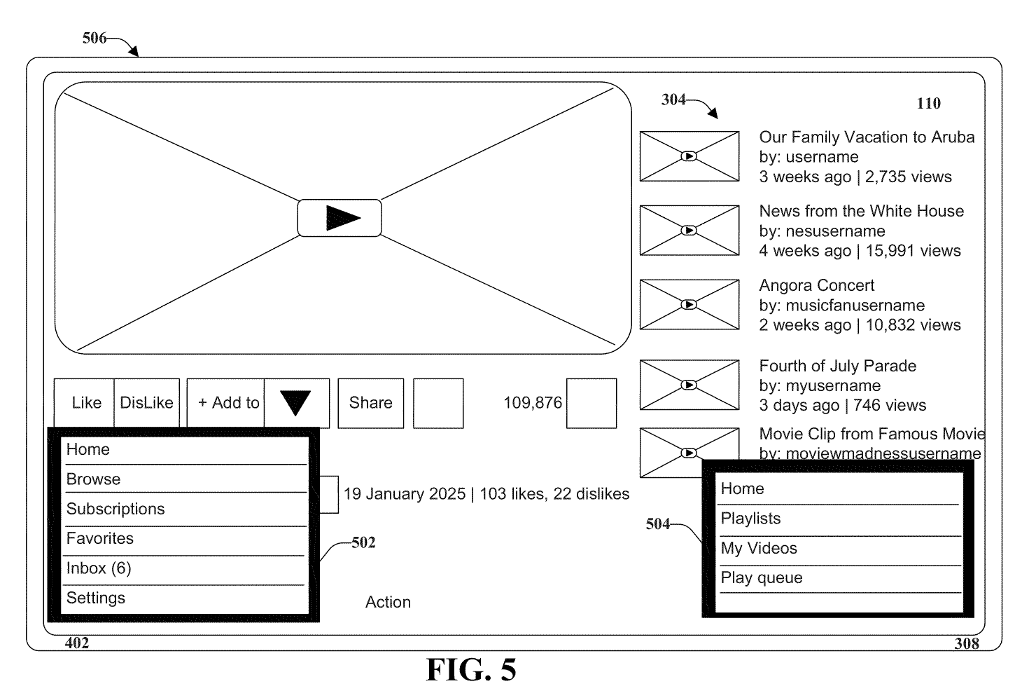

The example of FIG. 3 illustrates a right layout 306, wherein the floating control bar in a right bottom portion 308 of the display. However, the floating control bar can be located on the left bottom portion 402 of the display 110, as illustrated in the left layout 404 of FIG. 4. Further, in accordance with some aspects, the floating control bar can be divided between both the left bottom portion 402 of the display 110 and the right bottom portion 308 of the display 110. In accordance with another example, more than one floating control bar can be utilized. In the aspects where more than one floating control bar is utilized, each floating control bar can comprise different control features. However, in some aspects, at least one control feature can be duplicated in the two or more floating control bars. A non-limiting example line-drawing of a display that renders at least two floating control bars is illustrated in FIG. 5, wherein a first floating control bar 502 is located on the left bottom portion 402 and a second floating control bar 504 is located on a right bottom portion 308.

With reference again to FIG. 1, also included in system 100 is a retention component 116 that can maintain the subset of the control features at the modified placement. The retention component 116 can receive information related to the modified placement from the adjustment component 114. In some aspects, the retention component 116 also receives information related to the default position from the navigation component 106.

In an example, a tablet computer can be used in landscape mode and the adjustment component 114 may have modified the placement of the one or more control features when in landscape mode. However, over time, the user might desire to view screen contents in portrait mode and, therefore, the user changes an orientation of the tablet computer so that images within the display can be viewed in portrait mode. The user can change the orientation through a configurable setting, by physically changing the orientation of the device by holding the device so that the display is viewed in the correct orientation, and so forth.

Retention component 116 can maintain the subset of the control features at a similar position for both the portrait and landscape orientation. For example, a first subset of control features are located in a bottom right corner and a second subset of control features are located in a bottom left corner. When the screen is changed from portrait to landscape mode, the retention component 116 can retain location of the first subset and second subset of control features at approximately the same location within the display with respect to the edges of the display (e.g., so that the user can reach the control features with his thumb). For example, the retention component 116 can store information related to the navigational area(s) associated with the user and use similar size navigational area(s) for both orientations (e.g., portrait and landscape).

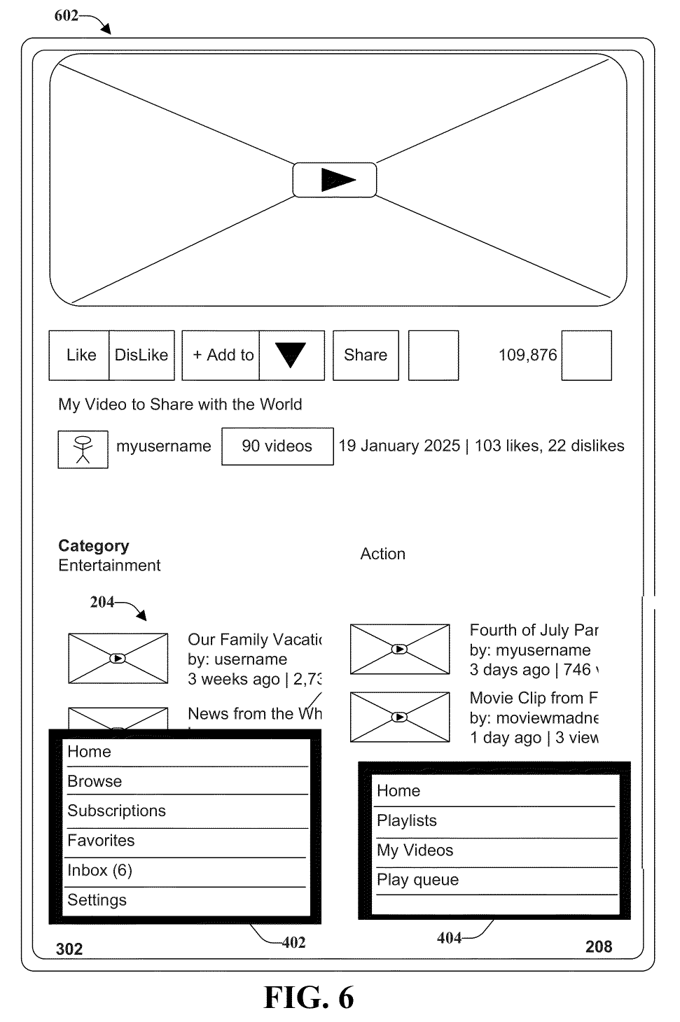

An example of an orientation change is illustrated in FIGS. 5 and 6, wherein FIG. 5 illustrates the display shown in a landscape orientation 506 and FIG. 6 illustrates a non-limiting example of the display shown in a portrait orientation 602. Although not illustrated, the examples of FIGS. 2, 3, and 4 could also be switched from portrait mode to landscape mode in a similar manner, according to an aspect.

In accordance with some aspects, retention component 116 can associate the modified placement with a specific user. In such a manner, the next time the user is operating the device, the user can be automatically recognized and the navigational controls can be sized and positioned according to the user's thumb (or hand size) and/or user preferences. Thus, the user can be distinguished from at least one other user and the user interface can be configured based on ergonomic considerations of the user, user preferences, and/or other parameters (e.g., display size, display orientation, the number of control features to be displayed, and so forth). Thus, there can be different settings for different users of the same device (or among a family of devices).

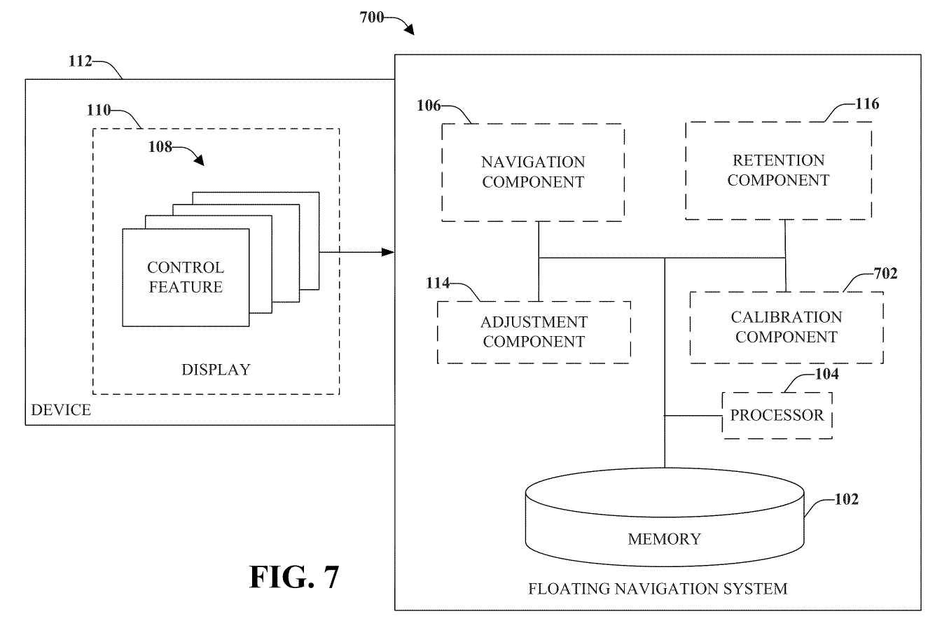

Turning now to FIG. 7, illustrated is another example non-limiting embodiment of system 700, according to an aspect. System 700 can employ a calibration component 702 that can identify a range of movement and/or size of a user's thumbs, according to an aspect. Based on the movement range and/or size of the user's thumbs, the control features and/or floating control bar can be orientated on the display (e.g., within a navigational area) and/or sized appropriately for the user.

Since different users can have different hand sizes and/or range of motion, calibration component 702 can evaluate the features of the user and provide input to other system components (e.g., navigation component 106, adjustment component 114, retention component 116, memory 102, processor 104, and so forth) to allow the control features 108 (and/or floating control bar(s)) to be adjusted accordingly for the user. The control features 108 and/or floating control bars should be based on the user's ergonomics and should be comfortable for the user (e.g., not too big, not too small, and so forth). Calibration component 702 can thus learn the best areas to place the control features for the user and the control features can be automatically placed at those locations the next time the user interacts with the tablet computer.

In accordance with some aspects, the range of movement and/or size of each thumb are determined individually. If the user does not want to (or cannot) use a particular thumb, the orientation and/or sizing is provided for the thumb that the user wants to (or can) utilize to control the tablet computer. After the initial set-up procedure (or at a different time), the user can manually reconfigure the set-up as desired. Calibration component 702 can initiate a set-up procedure to automatically provide a recommended placement and/or sizing of the control feature(s) and/or floating control bar(s). In accordance with some aspects, the placement and/or sizing can be automatically adjusted by the calibration component 702 and/or another component of system 700 when additional information about the user is obtained. Examples of additional information can include user preferences and/or an observed difficulty by the user to navigate and/or use the control features and/or floating control bar.

To initiate the set-up procedure, the calibration component 702 can cause a set of instructions or prompts to be output on the display 110 and/or through audio speakers. For example, calibration component 702 can instruct the user to hold the device in a comfortable manner and move his thumbs around (e.g., up and down) along the sides of the display (e.g., the lower left and right areas of the display) and/or perform a circular rotation with his thumbs. The calibration component 702 can track the movement and measure the length that the user's thumbs extend into the display (horizontally) and the amount that the user's thumbs extend vertically, which can define the navigational area(s). The measurements and/or extension position information can be conveyed to the adjustment component 114, which can place the control features 108 and/or floating control bar at a position that should be comfortable for the user. For example, if the user's thumbs extend horizontally into the display a short distance, the control features and/or floating control bar can be placed close to the perimeter of the display 110. However, if the user's thumbs extend farther into the display (e.g., the user's thumbs are long), the control features and/or floating control bar might be placed a little further into the display (e.g., further away from the perimeter of the display 110). In addition, the vertical positioning of the control features and/or floating control bar (e.g., floating control bar height) can be adjusted for the user in a similar manner.

In accordance with some aspects, to initiate the set-up procedure, the calibration component 702 can provide the set of instructions or prompts to the user in the form of a game. For example, the calibration component 702 can cause visual items to be rendered on the display, wherein the visual items provide an indication of how the user should move his thumbs so that the system 700 can determine the correct orientation and/or sizing of the control features and/or floating control bar. The visual items can be rendered such that the user can attempt to track the motion of the visual items with his thumb(s). In accordance with some aspects, the visual items can be three dots, for example, and the user can be instructed to try to hit the three dots with his thumb, wherein the tracking of each thumb is performed individually (e.g., first the left thumb and then the right thumb is tracked). Calibration component 702 can ascertain range of motion and/or size of the user's thumb(s) based on whether (or not) the user can hit (or touch) the three dots with the respective thumb. In accordance with some aspects, if the user cannot touch any one of the three dots on the display (e.g., without moving his entire hand), the one or more dots can be adjusted and one or more other opportunities can be provided to the user to touch the dots at the displayed locations. In accordance with some aspects, the ratio or percentage that the user misses a dot can be factored into the determination of a more appropriate sizing and/or orientation of the one or more control features and/or one or more floating control bars.

In accordance with some aspects, to identify the size of the user's thumbs, and coordinate appropriately sized control features and/or floating control bars, the calibration component 702 can identify the amount of surface area (on the display) that is being touched by each thumb (e.g., pad area of the thumb). If the user's hands are large, a larger surface area might be touched by the user's thumb. In a similar manner, if the user's hands are small, a smaller surface area might be touched by the user's thumb. Therefore, based on the amount of surface area being touched, the size of the control features (and/or floating control bar) can be adjusted such that the control features are not inappropriately sized. For example, a user with large thumbs might have trouble selecting a control feature that is small and, therefore, might select an undesired control feature and/or accidently select a different element on the display. If, on the other hand, the user's thumbs are small, control features and/or floating control bars that are large might cause the user to have to move her hand to select the appropriate item due to the size (e.g., length, height) of the items that can be selected. Thus, calibration component 702 can consider the appropriate sizing of the one or more control features.

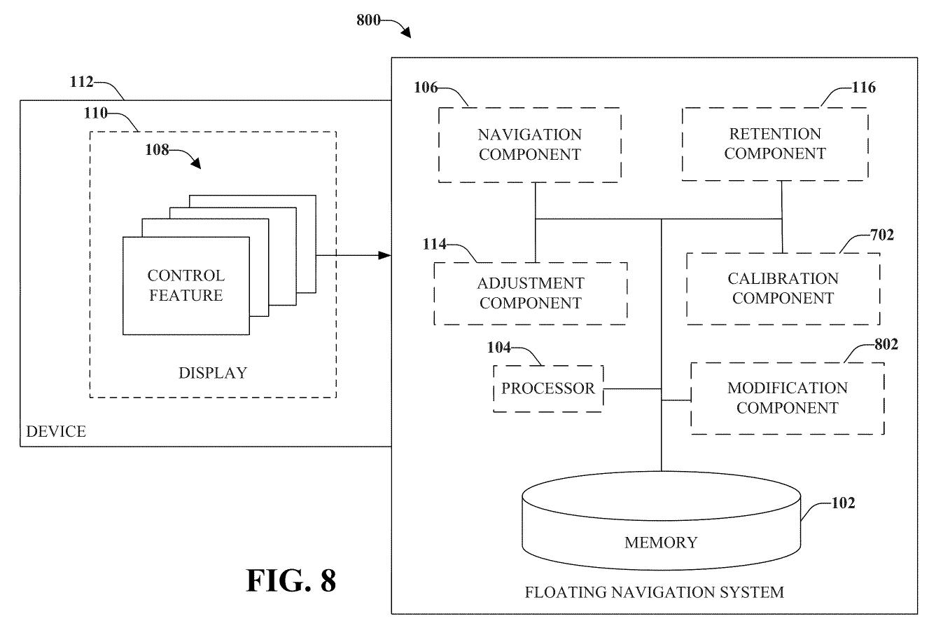

FIG. 8 illustrates another example non-limiting embodiment of system 800, according to an aspect. System 800 can employ a modification component 802 that can allow a user to fine tune one or more control features and/or floating control bars. Modification component 802 can interface with calibration component 702 and/or other system components in order to allow a user to adjust one or more of a size, a position, and/or an orientation of the control features and/or floating control bar(s). The adjustment can be communicated to retention component 116, which can associate the adjustments with the user (e.g., identified by a username, username/password pair, or through other manners, such as a biometric feature).

The adjustment to the one or more control features and/or floating control bars can be received by modification component 802 based on a movement or gesture of the user's hand (or portion thereof, such as fingers or thumb). For example, a control feature can be placed on the display (within a navigational area) based on a set-up procedure conducted by calibration component 702. At about the same time the control feature is placed and sized, the user might drag his hand across the display and (attempt to) nudge the control feature slightly (e.g., to the left, to the right, up, down, and so forth). Based on the hand movement, modification component 802 can change the position of the control feature in the direction indicated (e.g., if the hand motion is upward, adjustment component 114 can move the control feature so that it is positioned slightly higher on the display).

In accordance with some aspects, the user might indicate an upward motion, which can be perceived by the modification component 802 that the control feature should be moved higher on the display. The adjustment can be facilitated by adjustment component 114. However, the user might next indicate a downward motion with respect to the same control feature. Instead of interpreting the motion as a desired movement of the control feature, modification component 802 can interpret the motion as adjusting a size of the control feature. Therefore, adjustment component 114 can increase the height of the control feature in accordance with this example.

According to various aspects, modification component 802 can solicit feedback from the user if a movement or other indication from the user is unclear. Continuing the above example, if the user indicates an upward motion with his hand, modification component 802 can output a question to the user (e.g., in the form of a prompt), asking whether the control feature should be repositioned or resized. The user can select the desired action, such as by touching the respective word with his thumb, wherein modification component 802 communicates the desired action(s) to the adjustment component 114 for the appropriate change to the control feature.

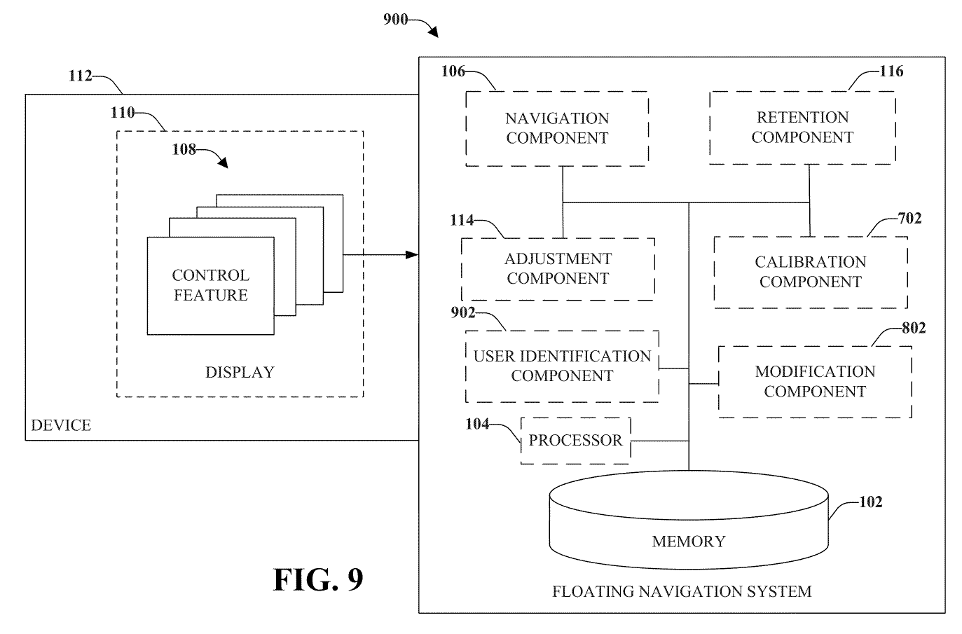

FIG. 9 illustrates another example non-limiting embodiment of system 900, according to an aspect. System 900 can employ a user identification component 902 that can identify a current user of the tablet computer. For example, a tablet computer might be utilized by more than one user, such as members of a family, a group of friends, and so forth. In another example, a family of tablet computers might be utilized by a set of users. In a specific example, a family (e.g., father, mother, and three children) might own a group of three devices, which can be utilized by any member of the family. Thus, if the daughter walks into a room of the house and a device has been left on a table in the room, the daughter might decide to use that particular device to perform various functions (e.g., watch videos posted by her friends, watch videos posted by others but which might be of interest to the daughter, as well as other actions). To improve a user experience (e.g., the daughter's experience in this example), user identification component 902 can dynamically recognize that the daughter is the current user of the device.

To facilitate the recognition by user identification component 902, information related to each person that can interact with the device can be retained in memory 102 (or another system component). For example, a username or username/password pair might be entered in order for the person to interact with the device and user identification component 902 utilizes the username information to configure the device for the user. In accordance with some aspects, user identification component 902 can utilize other manners of distinguishing the particular user. For example, the user might be recognized through biometrics (e.g., fingerprint, thumb print, eye scan, and so forth). Based, in part, on the information related to the person handling the device, user identification component 902 is configured to recognize the current person using the device and provide the information to retention component 116 (or other system components). In such a manner, the navigation controls or other configurable items are positioned and/or sized on the display for the particular user. The placement and/or sizing can be based on a set-up procedure previously (or automatically) implemented by calibration component 702 and/or based on other considerations (e.g., alterations implemented by modification component 802). For example, if the person recognized by user identification component 902 has conveyed preferences to system 900 (e.g., a first subset of controls on the left-hand side and a second sub-set of controls on the right-hand side), such preferences are dynamically implemented, regardless of the preferences of the most recent (previous) user of the device.

In accordance with some aspects, a subset or family of devices might communicate amongst each other to provide user identification and/or preference information. For example, a family of three devices are utilized and the daughter has been using a first device and calibration component 702 and modification component 802, associated with first device, have configured the system for the daughter. When the daughter decides to use a second device, the first device and second device can communicate such that the daughter's information is communicated from the first device to the second device. In an aspect, the communication occurs at about the same time the daughter begins to utilize the second device. However, according to some aspects, the communication occurs at a different time. For example, the identification and preference information can be stored in a back end of the first device (in the above example) and communicated to the second device (and/or third device) at substantially the same time as other information is communicated (e.g., services that are communicate through the back end).

The information communicated between the devices (or between disparate devices, which can be devices that are not within the same group of devices but communicate over the Internet, for example) can be utilized as a starting point for improving the user experience through the use of floating navigational controls as disclosed herein. For example, the configuration for the user might be small controls, located near the bottom left side edge of the device. The second device can utilize this information and calibrate the preferences as a function of the display size, orientation, and other features of the second device (which might be different than the features of the first device).

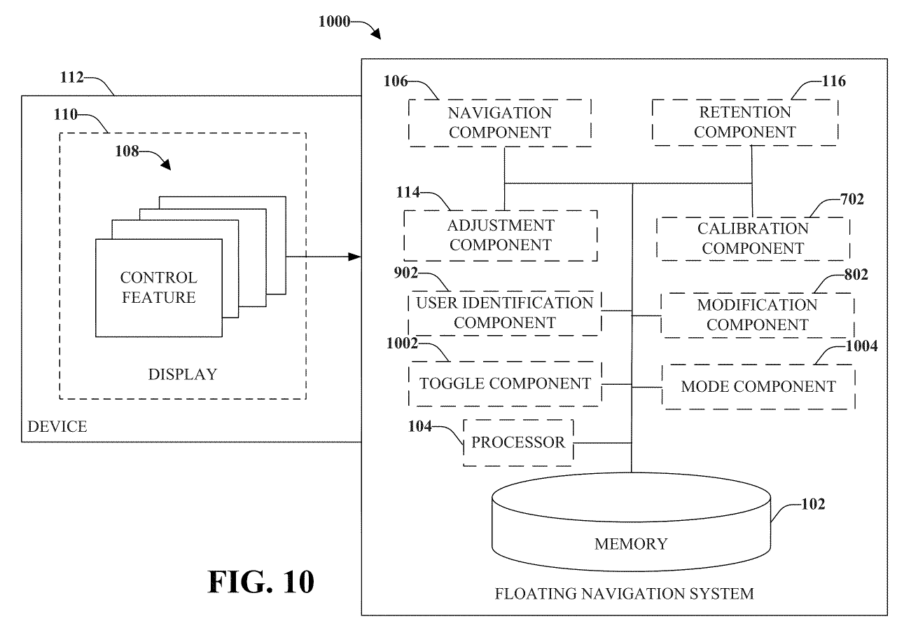

FIG. 10 illustrates another example non-limiting embodiment of system 1000, according to an aspect. System 1000 can employ a toggle component 1002 that can adjust a positioning of the navigation elements as a function of whether the user is left-handed or right-handed. In accordance with some aspects, system can additionally or alternatively employ a mode component 1004 that can adjust positioning of the navigation elements based on whether the display elements are rendered in portrait mode or in landscape mode.

The toggle component 1002 can automatically adjust the settings based on left-handed mode or right-handed mode. For example, if a user picks up a device with his right hand and begins to move his right thumb, toggle component 1002 can recognize that the movement is on the right and can instruct the adjustment component 114 to move the controls to the lower right portion of the screen. The controls can be further adjusted by other system components, which can take into account the range of motion of the user's thumb, the size of the user's thumb, user preferences, as well as other considerations.

In accordance with some aspects, toggle component 1002 can modify placement of a floating control bar within the tablet display as a function of left-handed mode or right-hand mode. The user's setting with respect to the controls can be adjusted based on user calibration metrics. For example, the floating control bar can be placed in the correct (or more appropriate) portion of the display (e.g., left, right) before calibration and/or other adjustments are made by system.

According to some aspects, toggle component 1002 can infer the most appropriate position for the navigation controls and/or floating control bar without interaction from the user. Further, toggle component 1002 (as well as other system components) can perform respective functions in the background without the user of the device being aware of the different actions being performed by the system components. For example, when a person picks up the tablet, the person might instinctively put their thumbs on the computer screen. Based on this, toggle component 1002, and other system components (e.g., adjustment component 114, calibration component 702, modification component 802, and so forth), can infer what the correct (or most appropriate) location should be and/or the appropriate sizing of the controls.

In accordance with some aspects, the mode component 1004 can automatically adjust position and/or the size of the navigation elements as the user moves the device (and screen) from portrait mode to landscape mode or from landscape mode to portrait mode. To change between portrait and landscape mode, the user can simply turn the device (or screen) as appropriate. Mode component 1004 is configured to realize that the change has occurred and can adjust the positioning and/or sizing of the navigational controls based on the detected change.

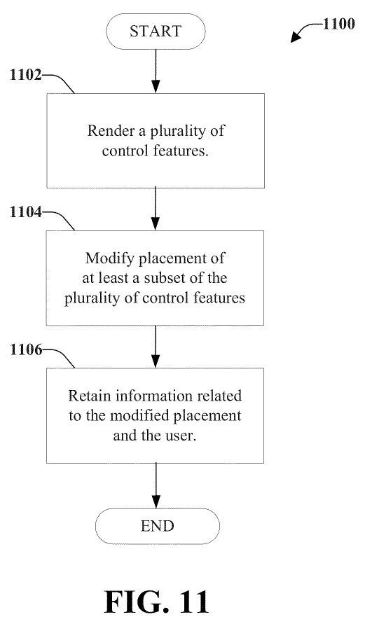

FIG. 11 illustrates an example non-limiting method 1100 for providing floating navigational controls, according to an aspect. While, for purposes of simplicity of explanation, the methods are shown and described as a series of acts, the disclosed subject matter is not limited by the order of acts, as some acts may occur in different orders and/or concurrently with other acts from that shown and described herein. For example, those skilled in the art will understand and appreciate that a method can alternatively be represented as a series of interrelated states or events, such as in a state diagram. Moreover, not all illustrated acts may be required to implement a method in accordance with the disclosed subject matter. Additionally, it is to be appreciated that the methods disclosed in this disclosure are capable of being stored on an article of manufacture to facilitate transporting and transferring such methodologies to computers or other computing devices.

Method 1100 can provide a dynamically adjustable user interface, wherein the navigational controls are placed in a configurable location so as to be easily accessed by the thumbs for touch screen actions. In accordance with some aspects, method 1100 can include using a processor to execute computer executable instructions stored in a memory.

Method 1100 starts, at 1102, when a plurality of control features are rendered on a display of a device (e.g., using a navigation component). The device can be a tablet computer, for example. The plurality of control features are the various commands that the user can select to perform operations with the device. For example, the plurality of control features can be rendered on the display at a default location for the plurality of control features.

At 1104, a placement of at least a subset of the control features within the display can be modified (e.g., using an adjustment component). The modification can be based in part on ergonomic considerations associated with a user. Modifying the placement of the subset of the control features can comprise modifying the placement as a function of a range of motion or a size of a thumb of the user, according to an aspect. For example, the modification can comprise relocating the subset of the plurality of control features within the display as a function of an orientation of the thumb(s) on a left bottom portion, a right bottom portion, or both the left bottom portion and the right bottom portion of the display. In another example, the modification can comprise modifying the placement of the subset of the plurality of control features within a navigational area of the display defined by a position of the thumb.

Information related to an association between the modified placement and the user is retained, at 1106 (e.g., using a retention component). The information can be utilized when the user again uses the device. For example, the next time the user begins to operate the device, the particular user can be detected (e.g., using a user identification component) and the information specific to that user can be accessed (e.g., using a retention component). According to an aspect, method 1100 can comprise recognizing the user of the tablet computer, obtaining the retained information, and outputting the at least the subset of the plurality of control features based on the retained information

In such a manner, the display can be configured as appropriate for the user without the need to recalibrate the device for the user (e.g., using a calibration component). In accordance with some aspects, the user can be distinguished from at least one other user (e.g., using a user identification component). For example, the user can be distinguished based on biometric features of the user or based on other criteria (e.g., username, username password pair, and so forth).

According to some aspects, the method 1100 can comprise detecting an orientation of the tablet computer has changed (e.g., using a mode component). Further to this aspect, the method 1100 includes switching the placement of the at least the subset of the plurality of control features to accommodate a change between a portrait orientation and a landscape orientation

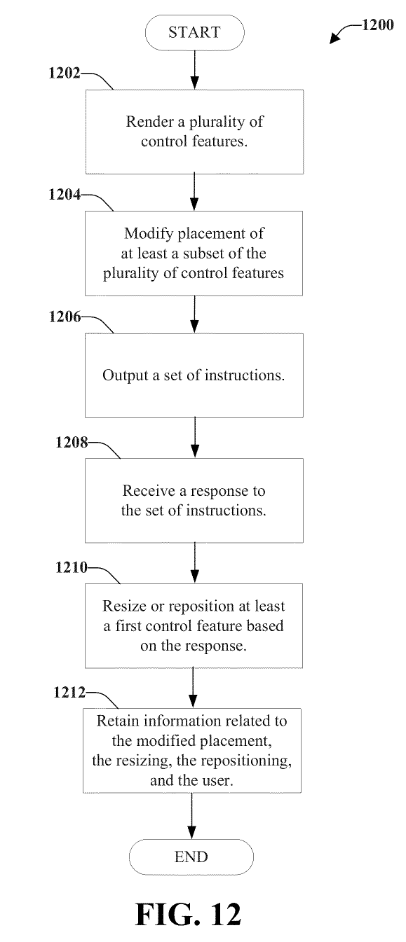

FIG. 12 illustrates another example non-limiting method 1200 for providing floating navigational controls, according to an aspect. Method 1200 starts, at 1202, when a plurality of control features are rendered on a display (e.g., using a navigation component). A placement of at least a subset of the plurality of control features can be modified at 1204 (e.g., using an adjustment component).

A set of instructions can be output, at 1206 (e.g., using a calibration component). The set of instructions can be designed to determine navigational area(s) that can be accessed by a user. For example, the navigational area(s) can be defined based on a range of movement and/or a size of the user's thumbs. In some aspects, the set of instructions can be output in a visual format and/or an audible format. For example, the set of instructions can indicate to the user how to move his thumbs in order for the device to ascertain the ergonomic considerations that should be utilized for the user.

At 1208, a response to the set of instructions can be received (e.g., using a user interface). For example, the response can be received in the form of a movement of the user's thumb over the display. The range of movement and/or the thumb pad area of the user can be measured from the received response. In accordance with some aspects, if a response is not received within a predetermined amount of time (e.g., a default time value), the lack of response can be interpreted as the user not desiring a change to the control features.

In some aspects, the lack of response might be only for one of the thumbs. For example, the user might not want to (or cannot) have any control features displayed on the right hand side of the display, and, therefore, does not move his right thumb in response to the instructions. Thus, at least a first control feature of the subset of control features can be resized or repositioned, at 1210, based on the response (e.g., using an adjustment component). At 1212, information related to the modified placement, the resizing, the repositioning, at the user is retained in a retrievable format (e.g., using a retention component).

In accordance with some aspects, the method 1200 can also include receiving (e.g., using a user interface) an adjustment to the first control feature after the reorienting or the repositioning and changing (e.g., using an adjustment component) an orientation or a position of the first control feature based on the adjustment. The change can be retained (e.g., using a retention component) as a portion of the information.

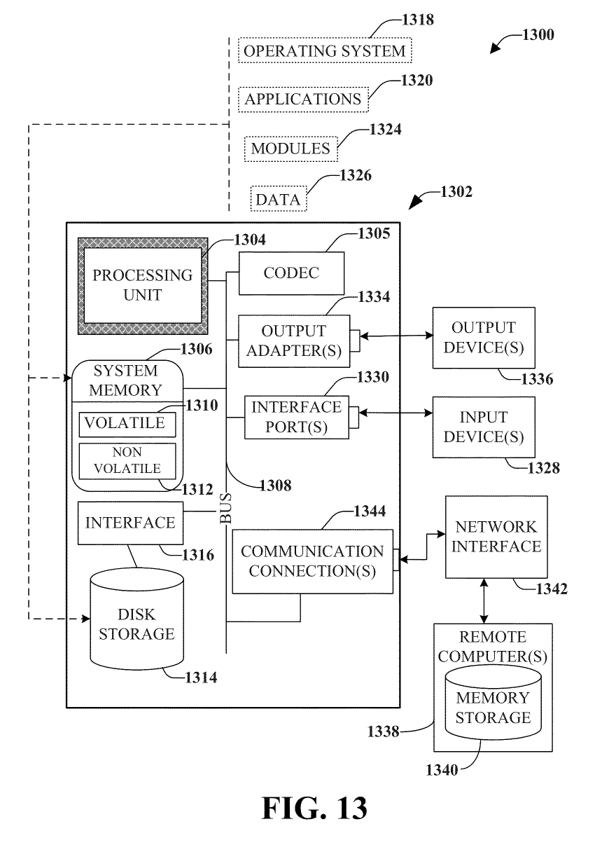

With reference to FIG. 13, a suitable environment 1300 for implementing various aspects of the disclosed subject matter includes a computer 1302. The computer 1302 includes a processing unit 1304, a system memory 1306, a codec 1305, and a system bus 1308. In one or more non-limiting implementations, the computer 1302 can be used to implement one or more of the systems or components described or shown in connection with FIGS. 1-10. The system bus 1308 couples system components including, but not limited to, the system memory 1306 to the processing unit 1304. The processing unit 1304 can be any of various available processors. Dual microprocessors and other multiprocessor architectures also can be employed as the processing unit 1304.

The system bus 1308 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1306 includes volatile memory 1310 and non-volatile memory 1312. The basic input/output system (BIOS), containing the basic routines to transfer information between elements within the computer 1302, such as during start-up, is stored in non-volatile memory 1312. In addition, according to an aspect, codec 1305 may include at least one of an encoder or decoder, wherein the at least one of an encoder or decoder may consist of hardware, a combination of hardware and software, or software. Although, codec 1305 is depicted as a separate component, codec 1305 may be contained within non-volatile memory 1312. By way of illustration, and not limitation, non-volatile memory 1312 can include read only memory (ROM), programmable ROM (PROM), electrically programmable ROM (EPROM), electrically erasable programmable ROM (EEPROM), or flash memory. Volatile memory 1310 includes random access memory (RAM), which acts as external cache memory. According to various aspects, the volatile memory may store the write operation retry logic (not shown in FIG. 13) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1302 may also include removable/non-removable, volatile/non-volatile computer storage medium. FIG. 13 illustrates, for example, disk storage 1314. Disk storage 1314 includes, but is not limited to, devices such as a magnetic disk drive, solid state disk (SSD) floppy disk drive, tape drive, Jaz drive, Zip drive, LS-70 drive, flash memory card, or memory stick. In addition, disk storage 1314 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1314 to the system bus 1308, a removable or non-removable interface is typically used, such as interface 1316.

It is to be appreciated that FIG. 13 describes software that acts as an intermediary between users and the basic computer resources described in the suitable operating environment 1300. Such software includes an operating system 1318. Operating system 1318, which can be stored on disk storage 1314, acts to control and allocate resources of the computer 1302. Applications 1320 take advantage of the management of resources by operating system 1318 through program modules 1324, and program data 1326, such as the boot/shutdown transaction table and the like, stored either in system memory 1306 or on disk storage 1314. It is to be appreciated that the disclosed aspects can be implemented with various operating systems or combinations of operating systems.

A user enters commands or information into the computer 1302 through input device(s) 1328 (e.g., a user interface). Input devices 1328 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1304 through the system bus 1308 via interface port(s) 1330. Interface port(s) 1330 include, for example, a serial port, a parallel port, a game port, and a universal serial bus (USB). Output device(s) 1336 use some of the same type of ports as input device(s) 1328. Thus, for example, a USB port may be used to provide input to computer 1302, and to output information from computer 1302 to an output device 1336. Output adapter 1334 is provided to illustrate that there are some output devices 1336 such as monitors, speakers, and printers, among other output devices 1336, which require special adapters. The output adapters 1334 include, by way of illustration and not limitation, video and sound cards that provide a means of connection between the output device 1336 and the system bus 1308. It should be noted that other devices and/or systems of devices provide both input and output capabilities such as remote computer(s) 1338.

Computer 1302 can operate in a networked environment using logical connections to one or more remote computers, such as remote computer(s) 1338 (e.g., a family of devices). The remote computer(s) 1338 can be a personal computer, a server, a router, a network PC, a workstation, a microprocessor based appliance, a peer device, a smart phone, a tablet, or other network node, and typically includes many of the elements described relative to computer 1302. For purposes of brevity, only a memory storage device 1340 is illustrated with remote computer(s) 1338. Remote computer(s) 1338 is logically connected to computer 1302 through a network interface 1342 and then connected via communication connection(s) 1344. Network interface 1342 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks such as Integrated Services Digital Networks (ISDN) and variations thereon, packet switching networks, and Digital Subscriber Lines (DSL).

Communication connection(s) 1344 refers to the hardware/software employed to connect the network interface 1342 to the bus 1308. While communication connection 1344 is shown for illustrative clarity inside computer 1302, it can also be external to computer 1302. The hardware/software necessary for connection to the network interface 1342 includes, for exemplary purposes only, internal and external technologies such as, modems including regular telephone grade modems, cable modems and DSL modems, ISDN adapters, and wired and wireless Ethernet cards, hubs, and routers.

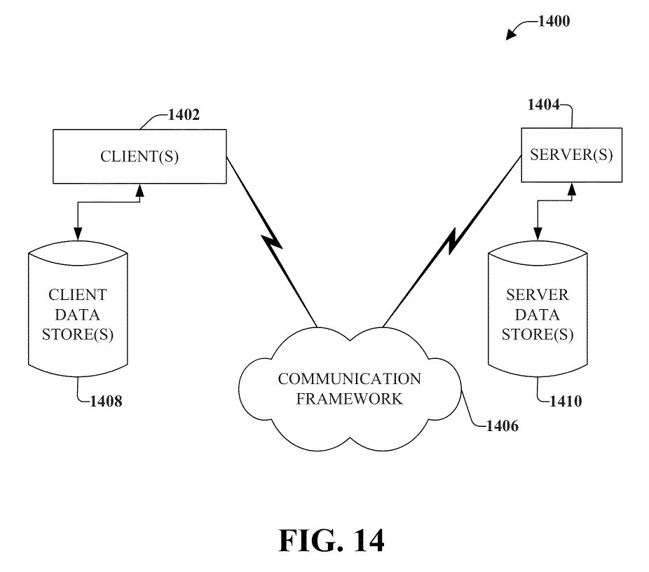

Referring now to FIG. 14, there is illustrated a schematic block diagram of a computing environment 1400 in accordance with the disclosed aspects. The computing environment 1400 includes one or more client(s) 1402 (e.g., laptops, smart phones, PDAs, media players, computers, portable electronic devices, tablets, and the like). The client(s) 1402 can be hardware and/or software (e.g., threads, processes, computing devices). The computing environment 1400 also includes one or more server(s) 1404. The server(s) 1404 can also be hardware or hardware in combination with software (e.g., threads, processes, computing devices). The servers 1404 can house threads to perform transformations by employing aspects of this disclosure, for example. One possible communication between a client 1402 and a server 1404 can be in the form of a data packet transmitted between two or more computer processes wherein the data packet may include video data. The data packet can include metadata, such as associated contextual information for example. The computing environment 1400 includes a communication framework 1406 (e.g., a global communication network such as the Internet, or mobile network(s)) that can be employed to facilitate communications between the client(s) 1402 and the server(s) 1404.

Communications can be facilitated via a wired (including optical fiber) and/or wireless technology. The client(s) 1402 include or are operatively connected to one or more client data store(s) 1408 that can be employed to store information local to the client(s) 1402 (e.g., associated contextual information). Similarly, the server(s) 1404 operatively include or are operatively connected to one or more server data store(s) 1410 that can be employed to store information local to the servers 1404.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of various embodiments. It is, of course, not possible to describe every conceivable combination of components or methodologies for purposes of describing the one or more aspects, but it is to be appreciated that many further combinations and permutations of the various aspects are possible. Accordingly, the subject disclosure is intended to embrace all such alterations, modifications, and variations. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the disclosed subject matter. In this regard, it will also be recognized that the aspects include a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art. Although the components described herein are primarily described in connection with performing respective acts or functionalities, it is to be understood that in a non-active state these components can be configured to perform such acts or functionalities.

In addition, while a particular feature may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, for example, via access requests, queries, or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, for example, a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In addition, while a particular feature of the disclosed aspects may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system, comprising:
a memory that stores computer executable components; and
a processor that executes the following computer executable components stored in the memory:
a navigation component that renders control features on a display of a tablet computer;
an adjustment component that modifies placement of the control features as a function of a user's thumb orientation; and
a retention component that maintains the control features at the modified placement.

2. The system of claim 1, wherein the adjustment component places a first subset of the control features at a left bottom portion of the display and a second subset of the control features at a right bottom portion of the display.

3. The system of claim 1, further comprising a calibration component that identifies at least one of a range of movement or a size of a user's thumb, wherein the adjustment component changes the placement of the control features in response to the range of movement or the size of the user's thumb

4. The system of claim 3, further comprising a modification component that receives a user modification to one or more of the control features, wherein the user modification relates to a size or a position of the one or more control features.

5. The system of claim 1, further comprising a user identification component that detects a user of the tablet computer, wherein the adjustment component modifies the placement for the user based in part on information received from the retention component.

6. The system of claim 5, wherein the user identification component detects the user based on a biometric feature of the user.

7. The system of claim 1, wherein the adjustment component modifies the placement of the control features within a navigational area of the display.

8. The system of claim 7, wherein the navigational area comprises an area within a range of movement of a user's thumb.

9. The system of claim 1, further comprising a toggle component that switches the placement of the control features between a left layout and a right layout based on whether a user is left handed or right handed.

10. The system of claim 1, further comprising a mode component that adjusts the placement of the control features as the tablet computer is changed between a portrait orientation and a landscape orientation.

11. The system of claim 1, wherein a floating control bar comprises the control features.

12. The system of claim 11, wherein the control features are transparently displayed to allow viewing of elements underneath the floating control bar.

13. The system of claim 11, wherein the floating control bar is a floating menu or a re-positionable menu.

14. The system of claim 11, wherein the floating control bar is accessible at a left bottom portion or a right bottom portion, or both the left bottom portion and the right bottom portion of the display.

15. A method, comprising:
using a processor to execute the following computer executable instructions stored in a memory:
rendering a plurality of control features on a display of a tablet computer;
modifying a placement of at least a subset of the plurality of control features within the display based in part on ergonomic considerations associated with a user; and
retaining information related to an association between the modified placement and the user, wherein the user is distinguished from at least one other user.

16. The method of claim 15, wherein the modifying comprises modifying the placement as a function of a range of motion or a size of a thumb of the user.

17. The method of claim 15, further comprising relocating the subset of the plurality of control features within the display as a function of an orientation of a thumb on a left bottom portion, a right bottom portion, or both the left bottom portion and the right bottom portion of the display.

18. The method of claim 15, further comprising modifying the placement of the subset of the plurality of control features within a navigational area of the display defined by a position of a thumb.

19. The method of claim 15, further comprising:
outputting a set of instructions;
receiving a response to the set of instructions; and
resizing or repositioning a first control feature of the at least the subset of the plurality of control features based on the response.

20. The method of claim 19, further comprising:
receiving an adjustment to the first control feature after the reorienting or the repositioning; and
changing an orientation or the positioning of the first control feature based on the adjustment, wherein the change is retained as a portion of the information.

21. The method of claim 15, further comprising:
recognizing the user of the tablet computer;
obtaining the retained information; and
outputting the at least the subset of the plurality of control features based on the retained information.

22. The method of claim 15, further comprising:
detecting an orientation of the tablet computer has changed; and
switching the placement of the at least the subset of the plurality of control features to accommodate a change between a portrait orientation and a landscape orientation.

23. A device, comprising:
a memory that stores computer executable components; and
a processor that executes the following computer executable components stored in the memory:
a navigation component that displays control features on a tablet computer display;
a calibration component that detects at least one of a thumb size or a range of movement;
an adjustment component that modifies placement of a first subset of the control features within a navigational area, wherein the navigational area comprises an area defined based on the thumb size or the range of movement;
a modification component that receives a change to one or more control features within the first subset, wherein the adjustment component applies the received change to the one or more control features; and
a retention component that associates the placement of the first subset of the control features with a user and stores information related to the association.

24. The device of claim 23, further comprising a user identification component that identifies a current user of the device, wherein the retention component retrieves the information related to the placement of the first subset of the control features for the current user and the adjustment component causes the first subset of the control features to be displayed at the modified placement.
